(19) United States
(12) Patent Application Publication
(10) Pub. No.: US 2010/0289808 A1
(43) Pub. Date: Nov. 18, 2010

(54) IMAGE PROCESSING APPARATUS, CONTROL METHOD THEREFOR, AND COMPUTER-READABLE STORAGE MEDIUM STORING COMPUTER-EXECUTABLE INSTRUCTIONS

(75) Inventor: Yosato Hitaka, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/768,609

(22) Filed: Apr. 27, 2010

(30) Foreign Application Priority Data
May 14, 2009 (JP) 2009-117654

(51) Int. Cl. G09G 5/00

(52) U.S. Cl. 345/581

(57) ABSTRACT

The present invention is directed to a technique which can display many images in such a manner that these images are easily compared and allow a user to easily select a desired image from among the images. During successively switching and displaying a plurality of images onto a display area, an image processing apparatus adds and displays a new image display area when an instruction to maintain display of a first image is issued, and maintains the display of the first image on the new image display area. Further, when an instruction to cancel maintaining of the display of the first image is issued, the newly added image display area is hidden or removed.

### BACKGROUND OF THE INVENTION

1. Field of the Invention

The present invention relates to an image processing apparatus configured to control switching and displaying a plurality of image files, a control method thereof, and a computer-readable storage medium storing computer-executable instructions.

2. Description of the Related Art

Conventionally, a large number of similar images can be photographed by using a continuous shooting function or a bracket shooting function of a digital camera, allowing a user to display a plurality of images for comparison.

For example, images of a fixed number designated by a user are multi-displayed, and a plurality of images are successively switched to be displayed. Further, when only images in a fixed number are arranged to be displayed, locked images are not changed to the other image, and only unlocked images are successively changed to the other images.

However, the number of the images to be displayed is conventionally fixed beforehand, so that a user cannot compare a desired number of images according to need, which is very inconvenient. In addition, when a large number of images are displayed at a time, the display size of each image becomes very small. Therefore, the display size of an image needed for comparison is decreased because of images being displayed that are not necessary for the comparison, making it difficult for a user to confirm the images. It is also troublesome for the user to set the desired number of images before he or she starts the comparing operation.

### SUMMARY OF THE INVENTION

The present invention is directed to a technique which can display many images in such a manner that these images are easy to be compared and allow a user to easily select a desired image without causing the user to do a troublesome operation.

According to an aspect of the present invention, an image processing apparatus includes a switching unit configured to successively switch and display a plurality of images on a first image display area, a receiving unit configured to receive an instruction to maintain display of a first image displayed on the first image display area, the first image being one of the plurality of images, an addition unit configured to add a second image display area which is different from the first image display area when the receiving unit receives the instruction to maintain display of the first image, and a display unit configured to display the first image on the second image display area. The switching unit successively switches and displays a second image from among the plurality of images which are not the first image, on the first image display area.

According to the present invention, image files in a number that a user desires are displayed with a simple operation, and the image files can successively be compared to the other image files. Therefore, usability is enhanced. Since only the image files in the minimum necessary number for the comparison of image files are displayed, the image files which are to be compared are displayed with a large size. Accordingly, it is easy for a user to visually confirm the image files, and can preferably compare target images from many images.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of an image processing apparatus according to the present invention.

FIGS. 2A to 2D illustrate an example of an image selection screen according to the present invention.

FIG. 3 is a flowchart illustrating an example of an operation of the image processing apparatus according to the present invention.

FIGS. 4A and 4B illustrate an example of image display control data according to the present invention.

FIG. 5 is a flowchart illustrating an example of an operation of the image processing apparatus according to the present invention.

### DESCRIPTION OF THE EMBODIMENTS

Various exemplary embodiments, features, and aspects of the invention will be described in detail below with reference to the drawings. Components described in the exemplary embodiment are only illustrative, and it is not construed that the scope of the invention is limited to those components.

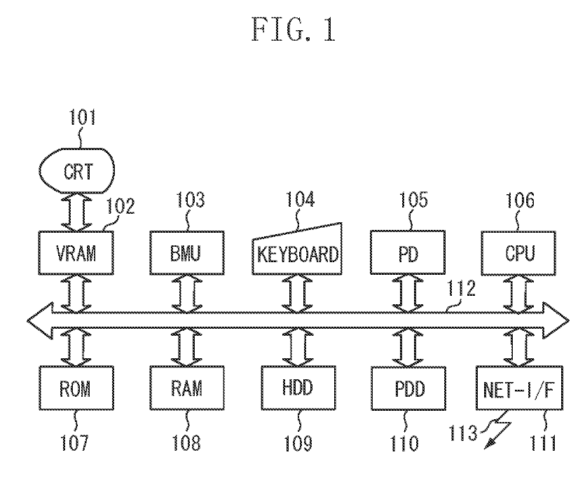

FIG. 1 is a block diagram illustrating a configuration of an image processing apparatus according to a first exemplary embodiment. An image processing apparatus 100 is realized by an information processing apparatus such as a personal computer, a cellular phone, and a digital camera. The image processing apparatus may be realized by a single information processing apparatus, or may be realized in such a manner that each function is distributed to a plurality of information processing apparatuses in necessary number. When the image processing apparatus includes a plurality of information processing apparatuses, they are connected by Local Area Network (LAN) in order that they can communicate with one another.

A display 101 displays, for example, an original image, a thumbnail image, and a user interface such as an icon, a message, and a menu. A video random access memory (VRAM) 102 stores drawing data for drawing the display contents described above on the display 101. The drawing data stored in the VRAM 102 is transferred to the display 101 according to a predetermined standard, so that an image can be displayed on the display 101. A bit move unit (BMU) 103 controls data transfer between memories (e.g., between the VRAM 102 and the other memory) or controls the data transfer between the memory and each input/output (I/O) device (e.g., network interface 111). A keyboard 104 inputs a character string or a command in response to an operation of a user. The keyboard 114 includes various keys. A pointing device (PD) 105 inputs a command in response to the user's operation. It is used to select the icon or the menu displayed on the display 101, for example.

A control unit (central processing unit (CPU)) 106 controls each device connected to the CPU 106 based on a control program or an application program stored in a read-only memory (ROM) 107 or a hard disk (HDD) 109. The ROM 107 stores various control programs and data pieces. A random access memory (RAM) 108 has a work area of the CPU 106, a save area of data during an error process, and a load area of the control program. The HDD 109 stores an application program such as an image selecting application program, and a content file such as an image file or a text file. A network interface (I/F) 111 connects the apparatus to network to communicate with an output apparatus such as an external information processing apparatus or a printer and an input apparatus such as a digital camera via Internet 113.

A CPU bus 112 includes an address bus, a data bus, and a control bus. The control program or the application program may be fed to the CPU 106 from the ROM 107 or the HDD 109. The control program or the application program may also be fed to the CPU 106 from the other information processing apparatus via the network interface 111 and the Internet 113.

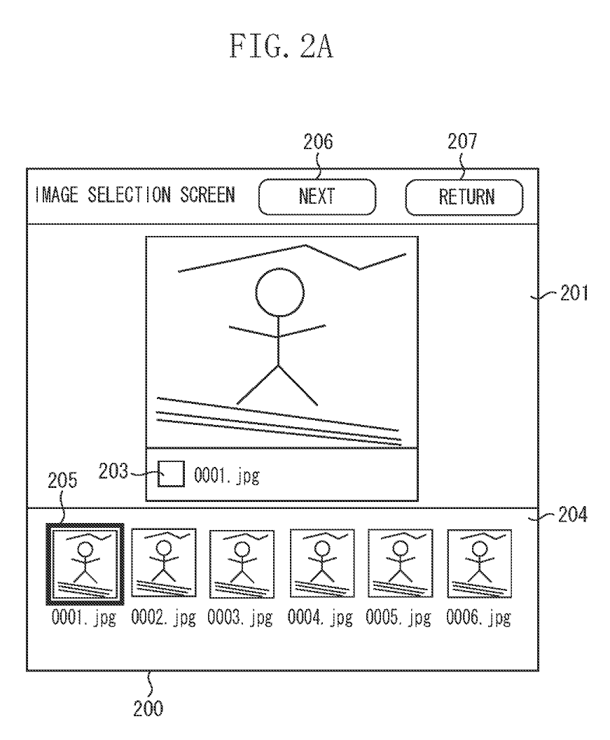

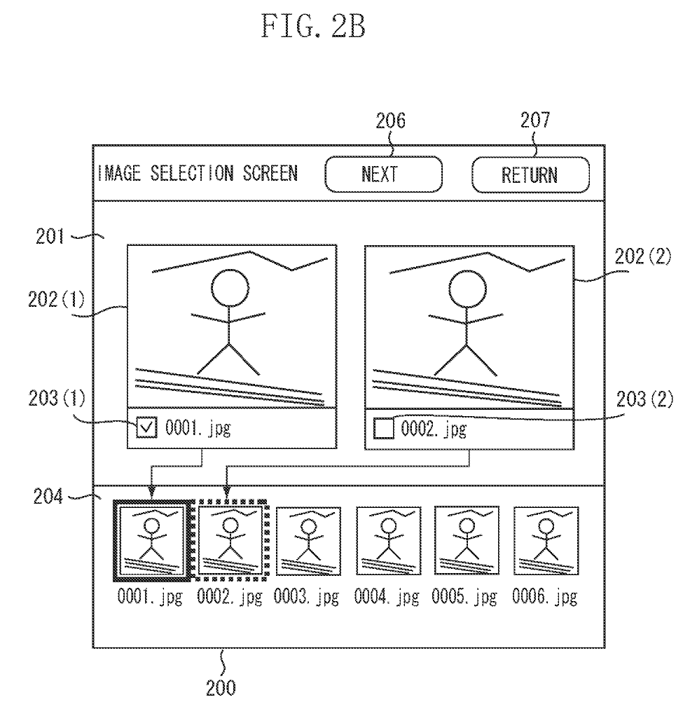

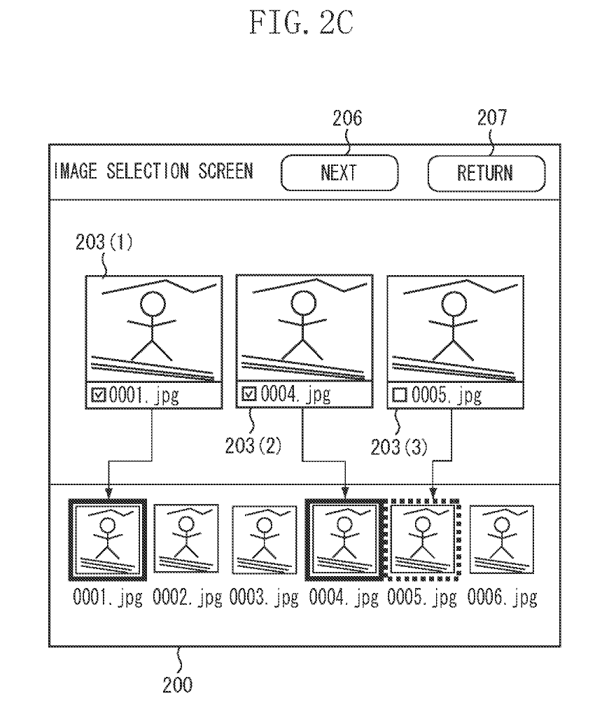

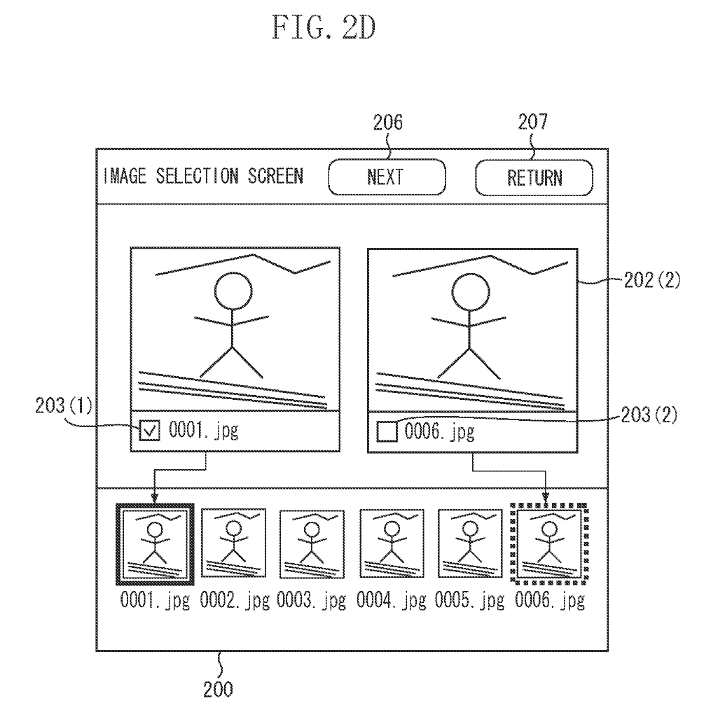

FIGS. 2A to 2D illustrate one example of an image selection screen 200 that is displayed on the display 101 by execution of an image selecting application program by the CPU 106 or operating system (OS) of the image processing apparatus 100.

FIG. 2A illustrates one example of the image selection screen 200 in the initial state. A display area 201 includes one image display area 202. A plurality of image files to be displayed is successively switched and displayed on the image display area 202. When a lock setting box 203 is turned ON (locked state), the switching operation of the display on the image display area 202 is stopped to maintain the display. When the lock setting box 203 is turned OFF (unlocked state), the stop of the switching operation is canceled to restart the switching operation of the display of the image files. Thumbnail images corresponding to the image files to be displayed are displayed in a list on a thumbnail image display area 204. When there is many image files to be displayed, the thumbnail image display area 204 is scroll-displayed. The thumbnail image corresponding to the image file displayed on the image display area 202 is displayed as being capable of identifying from the other thumbnail images. In FIG. 2, the thumbnail image corresponding to the image file displayed on the image display area 202 is displayed as enclosed by a bold line. Not only the image file described above is displayed as enclosed by the bold line, but also a display effect such as highlight or color conversion may be performed to the image file. Switching buttons 206 and 207 receive an instruction to switch the image file displayed on the image display area 202 to a previous image file or a following image file.

FIG. 2B illustrates one example of the image selection screen 200 that is displayed when a first image display area 202(1) is displayed as illustrated in FIG. 2A and the lock setting box 203(1) is changed to the ON state. A second image display area 202(2) and the corresponding lock setting box 203(2) are newly added to the display area 201. The image files subsequent to the image file displayed on the image display area 202(1) are successively switched and displayed on the image display area 202(2). The thumbnail image corresponding to the image file displayed on the image display area 202(2) is displayed on the thumbnail image display area 204 to be capable of identifying from the other thumbnail images. This thumbnail image is displayed to be capable of identifying from the thumbnail image corresponding to the locked image file displayed on the image display area 202(1). In FIG. 2B, the thumbnail image corresponding to the locked image file is displayed as enclosed by a bold line, while the thumbnail image corresponding to the unlocked image file is displayed as enclosed by a dotted line. In FIG. 2B, the image file displayed on the image display area 202 and the corresponding thumbnail image displayed on the thumbnail image display area 204 are linked with a line to better understand the correspondence relationship.

When the lock setting box 203(1) is changed to the OFF state from the ON state as illustrated in FIG. 2B, the image selection screen is returned to the one illustrated in FIG. 2A.

FIG. 2C illustrates one example of the image selection screen 200 that is displayed when the lock setting box 203(1) is in the ON state as illustrated in FIG. 2A, and the lock setting box 203(2) is changed to the ON state. A new image display area 202(3) and the corresponding lock setting box 203(3) are newly added to the display area 201. The image files subsequent to the image file displayed on the image display area 202(2) are successively switched and displayed on the image display area 202(3), except for the image file displayed on the image display area 202(1). The thumbnail image corresponding to the image file newly displayed on the image display area 202(3) is displayed on the thumbnail image display area 204 to be capable of identifying from the other thumbnail images.

FIG. 2D illustrates one example of the image selection screen 200 displayed when the lock setting box 203(2) is changed to the OFF state from the condition in which the lock setting boxes 203(1) and 203(2) are in the ON state as illustrated in FIG. 2C. The image display area 202(2) and the lock setting box 203(2) are deleted from the display area 201. The image files subsequent to the image file displayed on the image display area 202(3) are successively switched and displayed on the image display area 202(3), except for the image file displayed on the image display area 202(1).

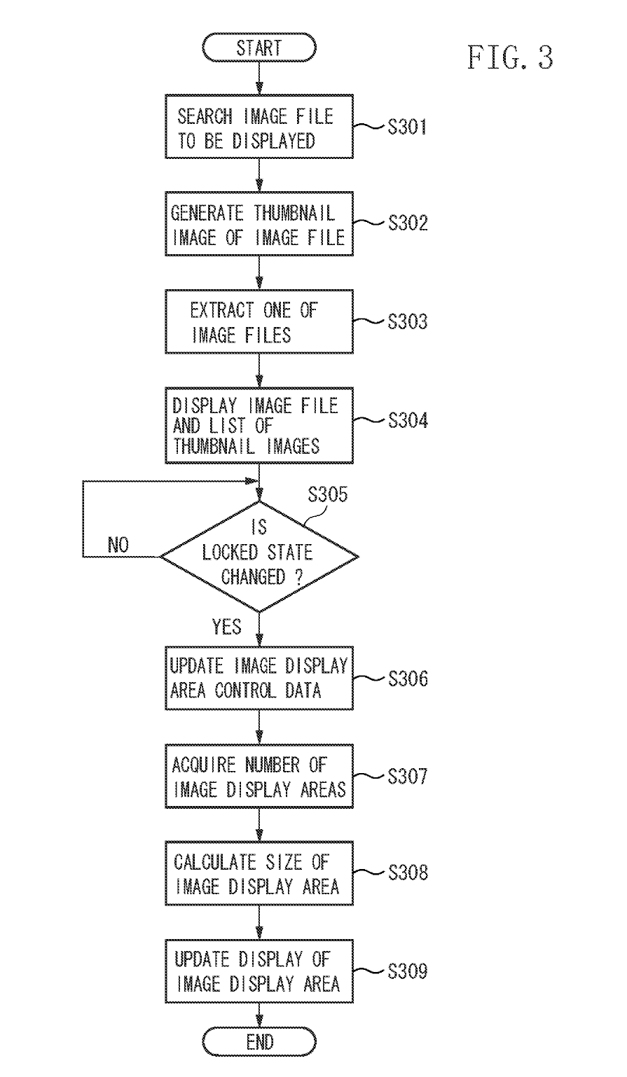

FIG. 3 is a flowchart illustrating one example of an operation to display the image selection screen 200 illustrated in FIGS. 2A to 2D on the display 101 of the image processing apparatus 100 according to the present exemplary embodiment. The operation executed by the image processing apparatus 100 is realized by the CPU 106 or the OS of the image processing apparatus 100 that reads the image selecting application program from the HDD 109 to start the same, and controls various devices.

In step S301, the CPU 106 searches the HDD 109 for the image file to be displayed. In step S302, the CPU 106 generates the thumbnail image corresponding to the searched image file. In this processing, an image file satisfying a predetermined condition is searched as a subject to be displayed. The image file satisfying the predetermined condition includes such as an image file that belongs to a folder designated by a user, and an image file having shooting date and time within a range designated by the user. The image file to be displayed has a predetermined order. The image files are displayed in an image switching manner on the image display area 202 in ascending order or descending order according to the predetermined order. Examples of the predetermined order include the order of a file name, the order of shooting date and time, and the order of user selection.

In step S303, the CPU 106 extracts one of the image files to be displayed. For example, the image file at the head of the image files to be displayed in the predetermined order is extracted. It is supposed that the image file “0001.jpg” is extracted in the present exemplary embodiment. In step S304, the CPU 106 performs control to display the image selection screen 200 in which the image file “0001.jpg” is displayed in the image display area 202 and a plurality of thumbnail images generated in step S302 is displayed in the thumbnail image display area 204, on the display 101. The lock setting box 203 corresponding to the image display area 202 is turned OFF.

In step S305, the CPU 106 detects whether the setting of the lock setting box 203 is changed. When the CPU 106 detects that the setting is changed (YES in step S305), in step S306, it updates display area control data 400.

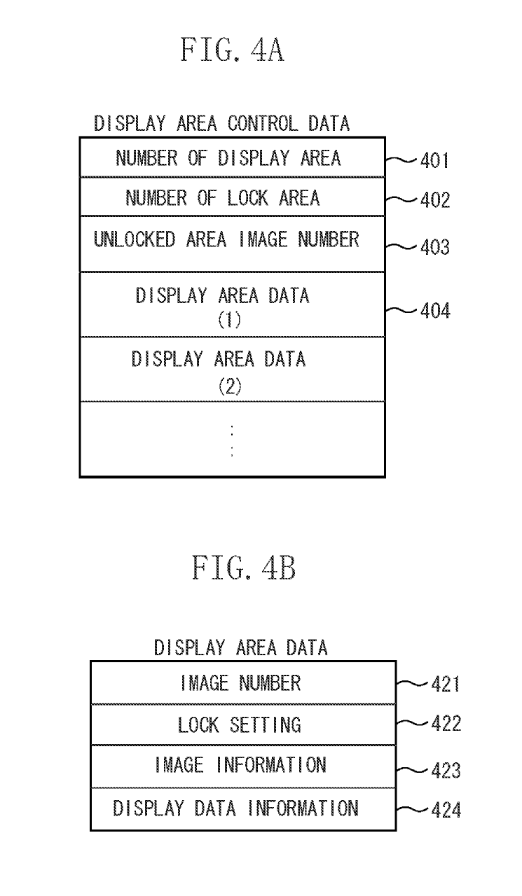

FIG. 4A illustrates one example of a data structure of the display area control data 400. A number obtained by adding “1” to the number of the image display areas in which the lock setting box 203 is turned ON is set to a number of an image display area 401. A number of a lock area 402 indicates a number of the image display areas in which the lock setting box 203 is turned ON. An unlocked area image number 403 indicates what number in the plurality of image files to be displayed is the unlocked image file displayed on the image display area 202, i.e., the image file in which the lock setting box 203 is turned OFF. Information about the image file displayed on the image display area is set to display area data 404. When the lock state of all pieces of the display area data 404 included in the display area control data 400 are turned ON as a result of changing the lock setting box 203 in step S305, new display area data 404 is added. Information about the image file following to the image file in which the lock setting box is last turned ON is stored in the new display area data. Further, the OFF state is set to the new display area data as an initial lock state. On the other hand, when the lock state of two or more display area data pieces 404 is turned OFF as a result of changing the lock setting box in step S305, the display area data 404 in which the lock setting box is last turned OFF is deleted.

FIG. 4B illustrates one example of a data structure of the display area data 404. An image number 421 indicates what number the image file is in the image files to be displayed. A lock setting 422 indicates whether the lock setting box of the image display area is turned ON or OFF. Image file information 423 indicates information for specifying the image file, e.g., a file pass (including a folder having the image file and the file name). Display data information 424 indicates information about the display of the image file. For example, trimming information indicating a display position and display magnification, editing information indicating a rotating direction or color adjustment, etc. are set to the display data information 424.

In step S307, the CPU 106 acquires the number of the image display areas 202 from the number of the image display area 401 of the updated display area control data 400. Then in step S308, the CPU 106 calculates the size of the image display area 202 from the number and the size of the display area 201. In step S309, the CPU 106 reads the image file specified by the image file information 423 in the display area data 404 from the HDD 109, edits the image file according to the display data information 424, and displays the edited image file on the image display area 202 having the size calculated in step S308. The CPU 106 further displays the lock setting box 203 corresponding to the image display area 202 according to the lock setting 422.

In a second exemplary embodiment, the number of the image display areas is not determined by detecting whether the state of the lock setting box is changed as in the first exemplary embodiment. In the second exemplary embodiment, it is described that the number of the image display areas is determined according to the state of the lock setting box when an instruction of image switching is given.

In the second exemplary embodiment, the image selection screen 200 in FIG. 2B is displayed when one image display area 202(1) is displayed as illustrated in FIG. 2A, and after the lock setting box 203(1) is turned ON, the instruction of switching the display is received by the switching button 206 or 207. The previous or following image file of the image file displayed on the image display area 202(1) are successively switched and displayed on the new image display area 202(2). When the lock setting box 203(1) is turned ON, and then, turned OFF as illustrated in FIG. 2B, and thereafter, the instruction of switching the display is received from the switching button 206 or 207, the image selection screen 200 is returned to the one illustrated in FIG. 2A.

The image selection screen 200 in FIG. 2C is displayed when the instruction of switching the display is received from the switching button 206 or 207 after the lock setting box 203(2) is turned ON while the lock setting box 203(1) is set to ON as illustrated in FIG. 2B. The previous or following image file of the image file displayed on the image display area 202(2) are successively switched and displayed on the new image display area 202(3), except for the image file displayed on the image display area 202(1).

The image selection screen 200 in FIG. 2D is displayed when the lock setting box 203(2) is turned OFF after the lock setting boxes 203(1) and 203(2) are turned ON as illustrated in FIG. 2C and the instruction of switching the display is received from the switching button 206 or 207. The previous or following image file of the image file displayed on the image display area 202(3) are successively switched and displayed on the image display area 202(2), except for the image file displayed on the image display area 202(1).

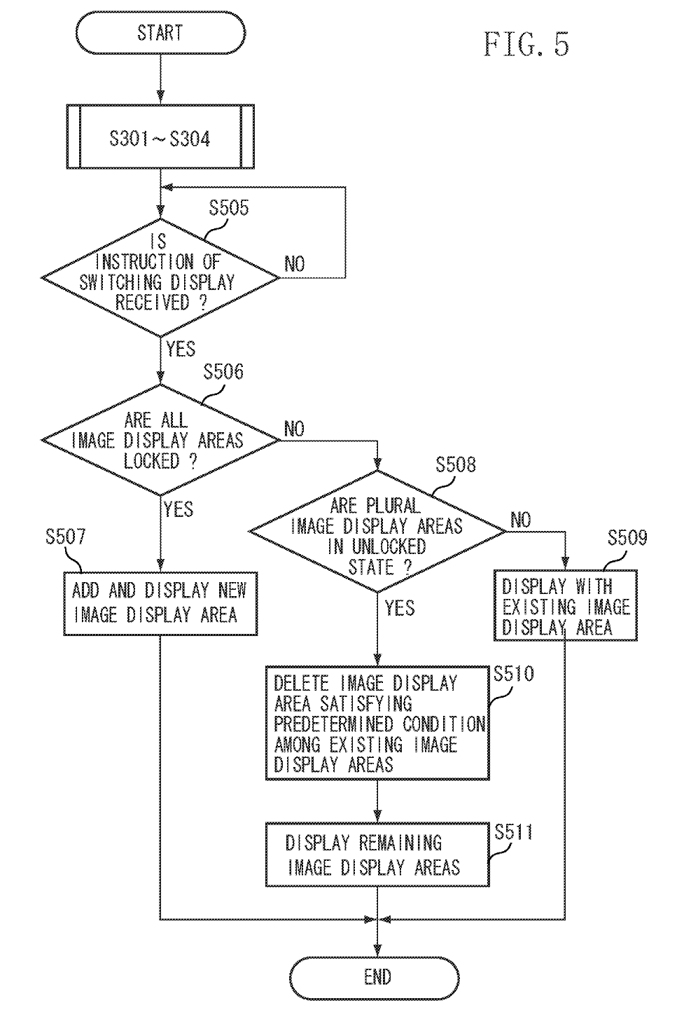

FIG. 5 is a flowchart illustrating one example of the operation that displays the image selection screen 200 illustrated in FIGS. 2A to 2D on the display 101 of the image processing apparatus 100 according to the present exemplary embodiment. The operation executed by the image processing apparatus 100 is realized by the CPU 106 or the OS of the image processing apparatus 100 that reads the image selecting application program from the HDD 109 to start the same, and controls various devices.

First, the CPU 106 executes the processing same as those in steps S301 to S304 in FIG. 3. In step S505, the CPU 106 determines whether there is an instruction to switch the image display. If it is determined that the instruction is given (YES in step S505), then in step S506, the CPU 106 determines whether the lock setting boxes 203 corresponding to all image display areas 202 are turned ON. When the CPU 106 determines that all lock setting boxes 203 are turned ON (YES in step S506), in step S507, a new image display area 202 and the corresponding new lock setting box 203 are added to the image selection screen 200 and displayed on the display 101 with the lock setting box 203 being turned OFF. If the instruction to switch the image display is given by the “RETURN” button 207, the image file “0006.jpg” which is one before the image file “0001.jpg” displayed on the last locked image display area 202 is displayed on the new image display area 202. The predetermined order of the image file is circulated. On the other hand, if the instruction to switch the image display is given by the “NEXT” button 206, the image file “0002.jpg” which is immediately after the image file “0001. jpg” displayed on the last locked image display area 202 is displayed on the new image display area 202. The size of each of the image display areas 202 is calculated based upon the total number of the image display areas 202 included in the display area 201 and the size of the display area 201.

If the CPU 106 determines that not all the lock setting boxes 203 are turned ON (NO in step S506), then in step S508, the CPU 106 determines whether there are a plurality of lock setting boxes that are set OFF. If a plurality of lock setting boxes are not set OFF (NO in step S508), then in step S509, the CPU 106 switches the display to the image file immediately before or immediately after the image file “0001.jpg” on the image display area 202. More specifically, if the instruction to switch the display is given by the “RETURN” button 207, the CPU 106 switches the display on the image display area 202 to the image file “0006.jpg” that is immediately before the image file “0001.jpg”. On the other hand, if the instruction to switch the display is given by the “NEXT” button 206, the CPU 106 switches the display on the image display area 202 to the image file “0002.jpg” that is immediately after the image file “0001.jpg”.

In step S508, when it is determined that there are a plurality of lock setting boxes 203 that are set OFF (YES in step S508), then in step S510, the lock setting boxes 203 satisfying the predetermined condition and the corresponding image display areas 202 are deleted from the display area 201. The predetermined condition includes, for example, the one in which the lock setting box 203, which is one before the last lock setting box, is turned OFF. In step S511, the CPU 106 displays the image file on the image display area 202 which remains on the image selection screen 200. When the instruction to switch the image display is given by the “RETURN” button 207, the image file “0006.jpg” which is immediately before the image file “0001.jpg” that is finally unlocked is displayed on the image display area 202 in which the lock setting box is last turned OFF. On the other hand, when the instruction to switch the image display is given by the “NEXT” button 206, the image file “0002.jpg” which is immediately after the image file “0001.jpg” is displayed on the image display area 202 in which the lock setting box is last turned OFF. The size of each of the image display areas 202 is calculated based upon the total number of the image display areas 202 included in the display area 201 and the size of the display area 201. Since the number of the image display areas 202 is decreased, the size of the image display area 202 is increased.

In step S506, it is determined whether there is a plurality of (two or more) image display areas in which the lock setting box is turned OFF. However, the present invention is not limited thereto. It may be determined whether there are image display areas in optional number or more. Accordingly, a plurality of image files can successively be switched and displayed at a time. Therefore, a user can promptly confirm the image files, when there are a great number of image files.

As described above, in the first and second exemplary embodiments, after an instruction to stop the switch of the image file is received when a plurality of image files are displayed in the image switching manner, the display of the image file is continued, and a new image display area is added to successively switch and display the remaining image files. Further, when an instruction to cancel the stop of the switch of the image file is received, unnecessary image display areas are deleted and the image files are successively switched and displayed on the remaining image display areas. Accordingly, a user can fix the display of the image files in the desired number to compare the image files to the other image files, so that usability can be enhanced. Since only the image files in the minimum necessary number for the comparison of the image files are displayed, the image file to be compared can be displayed with a large size. Consequently, it is easy for the user to visually confirm the image file.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-117654 filed May 14, 2009, which is hereby incorporated by reference herein in its entirety.

What is claimed is:

1. An image processing apparatus comprising:
a switching unit configured to successively switch and display a plurality of images on a first image display area;
a receiving unit configured to receive an instruction to maintain display of a first image displayed on the first image display area, the first image being one of the plurality of images;
an addition unit configured to add a second image display area which is different from the first image display area when the receiving unit receives the instruction to maintain display of the first image; and
a display unit configured to display the first image on the second image display area,
wherein the switching unit successively switches and displays a second image from among the plurality of images which are not the first image, on the first image display area.

2. The image processing apparatus according to claim 1,
wherein the addition unit is configured to add a plurality of image display areas which are different from one another.

3. The image processing apparatus according to claim 2 further comprising:
a calculation unit configured to calculate a size of each of the plurality of image display areas based on the total number image display areas added by the addition unit,
wherein the plurality of image display areas are displayed with the size calculated by the calculation unit.

4. The image processing apparatus according to claim 1,
wherein the receiving unit receives an instruction to cancel display of the first image displayed on the second image display area, and
wherein the receiving unit comprises a deletion unit configured to delete the second image display area when the instruction to cancel display of the first image is received.

5. The image processing apparatus according to claim 1, further comprising,
a list display unit configured to display a list of thumbnail images, each thumbnail image in the list corresponding to one of the plurality of images,
wherein the list display unit displays the thumbnail images corresponding to the first and second images in the list with a distinction making the thumbnail images corresponding to the first and second images capable of being identified from one another.

6. A method for image processing comprising:
successively switching and displaying a plurality of images on a first image display area;
receiving an instruction to maintain display of a first image displayed on the first image display area, the first image being one of the plurality of images;
adding a second image display area which is different from the first image display area when the instruction to maintain display of the first image is received;
displaying the first image on the second image display area; and
successively switching and displaying a second image from among the plurality of images which are not the first image, on the first image display area.

7. A computer-readable storage medium storing computer-executable instructions there, which when executed by a computer, instruct the computer to perform the steps of:
successively switching and displaying a plurality of images on a first image display area;
receiving an instruction to maintain display of a first image displayed on the first image display area, the first image being one of the plurality of images;
adding a second image display area which is different from the first image display area when the instruction to maintain display of the first image is received;
displaying the first image on the second image display area; and
successively switching and displaying a second image from among the plurality of images which are not the first image, on the first image display area.
